(19) United States
(12) Patent Application Publication
(10) Pub. No.: US 2011/0167420 A1
(43) Pub. Date: Jul. 7, 2011

(54) AIRCRAFT UNIT FOR MANAGING AND STORING DATA RELATING TO ON-BOARD EQUIPMENT

(75) Inventor: Olivier Bastien, La Salvetat Saint-Gilles (FR)

(73) Assignee: AIRBUS OPERATIONS, Toulouse (FR)

(21) Appl. No.: 13/063,131

(22) PCT Filed: Sep. 8, 2009
(86) PCT No.: PCT/FR2009/051688

§ 371 Date: Mar. 9, 2011

(30) Foreign Application Priority Data
Sep. 10, 2008 (FR) 0856086

(51) Int. Cl. G06F 9/44

(52) U.S. Cl. 717/173; 717/168

(57) ABSTRACT

The on-board unit for an aircraft includes:
an updating device dedicated to the aircraft and suitable for sending data relating to on-board equipment to a data storage medium; and
a data-loading device suitable for being connected to the on-board equipment and for receiving data from the storage medium.

The invention relates to aircraft, and more particularly to managing downloadable data relating to on-board equipment.

Nowadays, numerous pieces of equipment on board aircraft include computers that are controlled by programs. It has become common practice to load such programs on board the aircraft while the aircraft is in use.

Such loading presents various advantages. It is easy to correct a piece of software by loading a modified version of the software on board, without physically changing the installation that makes use of the program. Similarly, updating software enables on-board systems to be upgraded without replacing them. Finally, the same pieces of equipment can be used for building aircraft of different types, insofar as it suffices to personalize the software loaded into such equipment. This concept is often referred to as “field loadable software”.

This technology assumes that a data-loading device is on board the aircraft. It is also necessary to provide a device for storing the data so as to constitute an emergency store for all of the software in case it should become necessary to load software again into any of the equipment. This could arise, for example, in the event of a piece of on-board equipment being exchanged as a result of an on-board failure.

On Airbus airplanes named A320, A330, and A340, different pieces of software are delivered on respective media. Each of these media is stored on board as a backup in a box known as a “floppy disk box”. As a result, the on-board reader device must include a reader that is compatible with each of the media stored on board.

On board the Airbus airplane named A380, a storage device is provided in electronic form that makes it pointless to conserve software media on board. That storage device is physically attached to the loading device and constitutes a back-up store in electronic form (somewhat like in a file system). Nevertheless, in the event of the loading device being removed or replaced, it is necessary to reload the storage device in full, and that can take a long time.

There is therefore a desire to improve the management of software on board aircraft. Nevertheless, in order to do this it is necessary to comply with various obligations.

1) Firstly, the on-board data-loading device must not give rise to an anomaly whereby software is loaded into a piece of equipment in untimely or involuntary manner, known as “untimely inadvertent uploading of avionics line replaceable unit (LRU)”. This anomaly is to be avoided, in particular because many of the pieces of equipment that include software that is capable of being loaded by this technology, are pieces of equipment that have an impact on safety.

2) It is also essential for an operator to be on board for all loading of software into a piece of equipment in order to enable the operator to start on-board loading and to verify, at the end of loading, that the selected configuration has been properly loaded into the equipment.

3) Finally, it is preferable for the loading device to allow the data storage device to be updated quickly in the event that it needs to be reloaded in full. This applies for example when the storage device or the equipment containing it has been removed from the aircraft following a failure.

In order to take the first constraint in account, when the storage device situated on board is not in use, two possibilities can be envisaged. Either it is permanently connected to the data storage device. Under such circumstances, the configuration of the storage device must correspond exactly to the configuration of the software that is already loaded, in order to ensure that, in the event of any untimely triggering on the ground, the equipment targeted by the loading that is then performed will remain in the same certified configuration. Or else, on the contrary, the storage device is physically disconnected from the loading device. Under such circumstances, the storage device may have a configuration that is different from that of the software being used in the equipment.

The second constraint implies that the storage device is accessible on board to an operator and that it always contains the configuration that ought to be loaded as a backup.

Concerning the third constraint, there are two possibilities. Either the on-board storage device is updated at a high transfer rate from physical media, even though this possibility is often limited by the technologies that can be used on board. Or else, redundancy is provided for on-board storage devices so as to improve the availability of data, even though that increases the complexity of the unit, thereby reducing the operational reliability of the storage device.

In addition, there is a demand from users for storage device management to be more flexible. Thus, it is desired that the on-board storage device can be updated remotely from the ground over a wireless connection (of the Gatelink, SATCOM, ACARS (aircraft communications addressing and reporting system) type, etc.). Furthermore, it is desirable for the on-board storage device to be capable of being pre-loaded with future versions of the software or of the databases so that updating of on-board equipment can be triggered at a later date. Finally, there is a desire to be able to store several different versions of a given software function in the device.

Because of the first constraint (no untimely or involuntary loading), it is not possible to satisfy such desires by means of a storage device that is permanently connected to the loading device (and consequently to the on-board equipment).

An object of the invention is thus to make the management of on-board software more flexible.

To this end, the invention provides an on-board unit for an aircraft, the unit comprising:
an updating device dedicated to the aircraft and suitable for sending data relating to on-board equipment to a data storage medium; and
a data-loading device suitable for being connected to the on-board equipment and for receiving the data from the storage medium.

The data will usually be constituted by programs, e.g. for controlling pieces of equipment (operational software, configuration files, etc.

Thus, the function of updating the storage medium is distinct from the function of loading data from that medium. It is thus possible to act on the updating device and to manage software within it without interfering with the operation of the data-loading device and thus with the on-board equipment.

Preferably, the updating device does not have a connection with the loading device.

This prevents the above-mentioned untimely or involuntary anomaly occurring. It is also possible to act on the updating device, e.g. in order to add a program thereto, or to delete a program therefrom, without having any influence on the loading device and the equipment connected thereto.

Preferably, the loading device and/or the updating device presents a respective predetermined location for removably receiving the data storage medium.

Because of the location of the loading device, in the event of an anomaly on any of the pieces of equipment, the data relating thereto is available on board without requiring a complex configuration for the storage medium. It then suffices to put the medium in the location of the loading device in order to load the corresponding software into the equipment in question. Furthermore, while the medium is not being used, it may be separated from the loading device and stored on board. This avoids the occurrence of an anomaly of untimely loading of software. The storage medium may be taken off the aircraft in order to be managed on the ground, and for example updated, and on board it may be replaced immediately with a medium that has been suitably prepared in advance. This reduces the length of time the aircraft needs to remain on the ground. Furthermore, the number of versions of a given piece of software that are present on board in the storage medium may be increased, in particular when the medium is physically disconnected from the loading device. This configuration also reduces the time required for reloading the storage medium when the updating device is exchanged following a failure. It suffices to remove the storage medium from the updating device that is taken away and to re-insert it into the replacement device. This provides the airline in charge of the aircraft with great flexibility in managing the storage medium, regardless of whether management takes place on board or on the ground by means of dedicated equipment.

Advantageously, the loading device is suitable for sending other data relating to the equipment to the storage medium.

Advantageously, the unit includes the data storage medium.

The invention also provides an aircraft including a unit of the invention.

Preferably, the updating device is suitable for receiving data relating to the equipment from outside the aircraft over a wireless connection.

Thus, it is possible to update the storage medium remotely via the updating device, regardless of whether the aircraft is on the ground or in flight. This updating may also be performed without any risk of interference with the loading device and the on-board equipment, in particular when the updating and loading devices are physically unconnected. By this means, and more generally, it is possible for management of the data on the storage medium to be performed remotely.

The invention also provides a method of loading data on board an aircraft, wherein, on board the aircraft:
an updating device dedicated to the aircraft sends data relating to equipment of the aircraft to a data storage medium; and
the storage medium sends the data to a data-loading device connected to the equipment.

Preferably, the storage medium is taken from a reception position in which it is suitable for receiving the data from the updating device to a transfer position in which it is suitable for transferring the data to the loading device.

Advantageously, the data storage device sends other data relating to the equipment to the storage medium.

The invention also provides a program including instructions suitable for controlling the execution of at least one of the steps of the method of the invention in the context of implementing said method when the program is executed on a computer.

Finally, the invention provides a data storage medium including such a program in stored form, and a method including a step of making such a program available for downloading on a telecommunications network.

Other characteristics and advantages of the invention appear further from the following description of an embodiment given by way of non-limiting example with reference to the accompanying drawings, in which:

FIG. 1 is a perspective view of an aircraft of the invention;

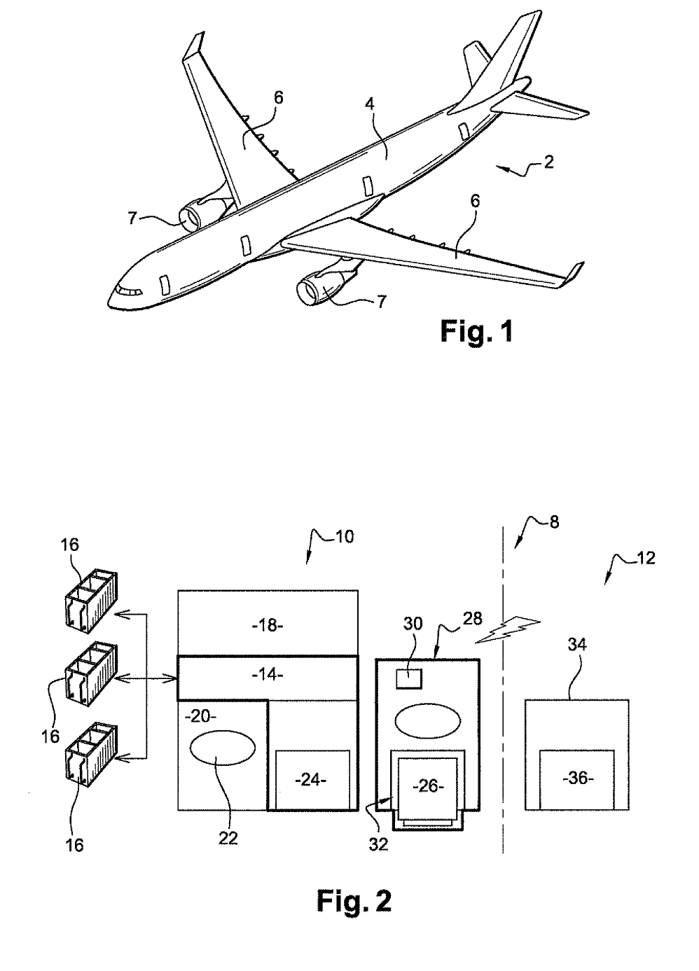

FIG. 2 is a diagrammatic view of a unit of the invention situated on board the FIG. 1 aircraft; and

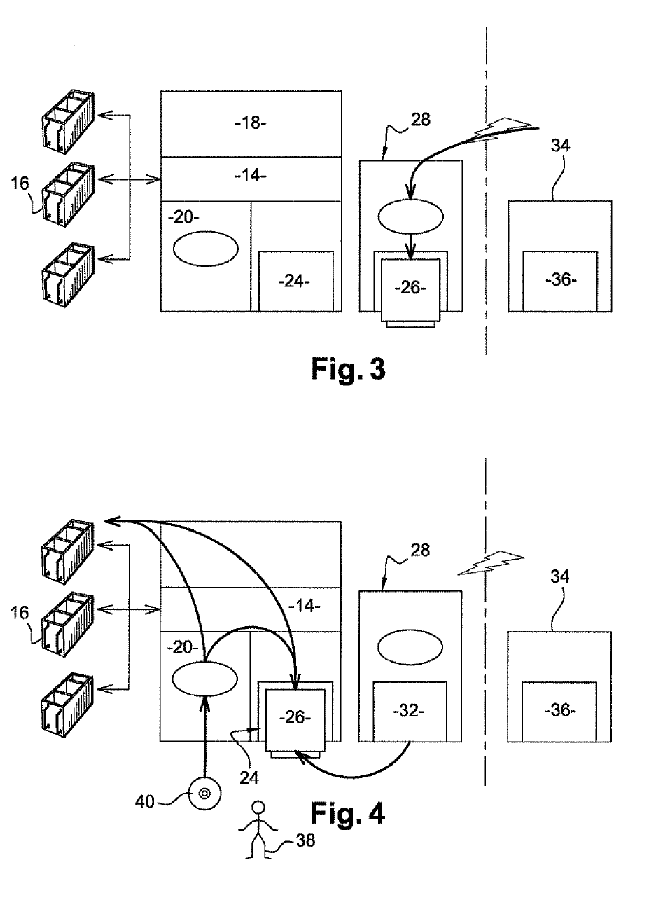

FIGS. 3, 4, 5, and 6 are views analogous to FIG. 2 showing various steps in the method of the invention implemented by means of the FIG. 2 unit.

FIG. 1 shows an aircraft of the invention, which specifically is an airplane. The airplane 2 has a fuselage 4, two wings 6, and two jet engines 7 carried by respective ones of the wings.

With reference to FIG. 2, there can be seen a system 8 comprising firstly a unit 10 situated on board the aircraft and secondly a device 12 situated outside the aircraft and arranged in stationary or movable manner on the ground, e.g. at the main base of the airline operating the airplane. The unit 10 forms part of the installations that are specific to the aircraft and necessary to enable it to operate properly.

The unit 10 includes a data-loading device 14. The data comprises computer programs serving in particular to control equipment on board the airplane such as the equipment 16 shown in FIG. 2. The equipment may relate to piloting, to on-board living conditions, etc. Each piece of equipment includes a computer comprising a central unit, memory means suitable for storing one or more programs used by the equipment, etc. The data-loading device 14 is hosted in this example within a host platform 18 that is optionally shared with other maintenance applications. Nevertheless, it is not essential for the device 14 to be hosted within such a platform.

The platform 18 includes a conventional data media reader. Such conventional media may comprise a compact disk (CD) or a digital video disk (DVD), a peripheral presenting a universal serial bus (USB) connection, a card of the personal computer memory card international association (PCMCIA) type, etc. Such reading is performed after prior execution of an authentication function by a module 22 of the reader.

The loading device 14 in the present example includes a location 24, such as a housing, for removably receiving a data storage medium 26 of predetermined type. The loading device 14 and the medium 26 may for example be configured in such a manner that when the medium is received in the housing 24 in a predetermined reception position, here referred to as the “transfer” position, it is automatically connected to the loading device 14 in order to be able to transfer data thereto and receive data therefrom.

The unit 10 also includes a device 28 for updating the medium 26. In the present example, the updating device does not have any connection with the platform 18, and in particular with the loading device 14, nor does it have any connection with the equipment 16. Although this characteristic is not essential, it is particularly advantageous, as described below. This updating device includes wireless radio connection means 30 that enable it to receive and send data remotely with the outside of the aircraft, and for example from the ground or to the ground. Like the loading device 14, the device 28 includes a location 32 for removably receiving the medium 26. Once the medium has been received in the reception position in the housing provided in this way, it is suitable for receiving data from the updating device and for transferring data thereto. Provision is made for the medium 26 to be received in this position in the updating device 28 when the loading device 14 is not in use. This is said to be a “standby” position.

On the ground, the system 8 includes a ground updating device 34 situated for example in the installations of the airline. Provision may be made for this device to present an interface with a data storage member of the airline. This device 34 likewise includes a location 36 for removably receiving the medium 26 in order to be capable of transferring data thereto and receiving data therefrom when it is received in the reception position in the location. Although it is advantageous to have the device 34, such a device is not essential for implementing the invention.

Each of the devices 14, 28, and 34 includes a computer comprising a central unit, memory means, etc.

The data medium 26 is of a predetermined type, distinct from conventional media 40, and preferably specific to the type of unit used on board aircraft.

There follows a description of the operation of the system 8 and the implementation of the method of the invention.

With reference to FIG. 3, the description relates initially to a step of remotely updating the medium 26, which step may take place regardless of whether the aircraft is in flight or on the ground.

When the aircraft is in flight or on the ground and the loading device 14 is not in use, provision is made for the medium 26 to be received in the location 34 of the updating device 28, in the standby position as described above. As a result, the medium 26 then has no physical connection with the on-board network, and in particular with the loading device 14 and the equipment 16.

It is then possible to access the medium 26 remotely from the ground in order to manage its configuration. It is thus possible to delete a piece of software from the medium, to add software thereto, or indeed to request a report from the medium concerning its configuration, and for this to be done without any risk relative to the on-board equipment 16. This possibility for acting remotely on the medium, which may be done when the aircraft is not at its main base, e.g. while it is in flight, provides the airline with great flexibility in managing the content of the medium 26.

Furthermore, since the medium 26 is physically disconnected from the loading device 14 and the equipment 16, the airline may store several versions of a single software function within the medium 26, e.g. in pre-loaded form in the medium prior to implementation in the equipment 16.

With reference to FIG. 4, there follows a description of the data-loading step.

As described with reference to FIG. 3, it is assumed that the medium 26 has been updated by adding at least one piece of software or a new version of some software. It is assumed that the airplane is on the ground. An operator 38 goes on board to load the software. For this purpose, the operator begins by extracting the medium 26 from its housing 32 and inserts it in the reception position in the housing 24 of the loading device 14. Once received in the location 24, the operator causes the medium 26 to send the necessary data to the device 14, e.g. a new version of software for one of the pieces of equipment 16. The device 14 then loads the data in question from the medium 26. Thereafter it transfers the data to the piece of equipment 16 concerned.

It is now assumed that data is to be loaded from a conventional data medium 40. As before, the operator extracts the medium 26 from the location 32 in order to put it in the location 24. The operator places the medium 40 in the reader 20. The medium 40 is authenticated therein. Thereafter, the loading device 14 loads the data present on the medium 40 and transfers it to the piece of equipment 16 concerned and also to the medium 26 present in the location 24. An emergency version of this data is thus now to be found on the on-board storage medium 26 and there is no need to keep the conventional medium 40 on board.

In both of the above two cases, when the loading operation has been completed, the operator 38 extracts the medium 26 from the location 24 and returns it to the standby position in its location 32 within the updating device.

In similar manner, FIG. 5 shows circumstances in which the wireless connection to the updating device 28 is not available, e.g. because of where the aircraft is located. Nevertheless, the presence of the reader 20 enables the medium 26 to be updated. As described above, the operator 38 goes on board to update the medium 26. The operator begins by extracting the medium 26 from the device 28 and placing it in the location 24 of the loading device 14. Using the conventional medium 40 placed in the reader 20, the operator loads the necessary data into the loading device 14 and then transfers it by means of the device 14 to the medium 26. The medium 26 is thus updated. Thereafter the operator extracts the medium 26 from the location 24 and returns it to the standby position in the location 32.

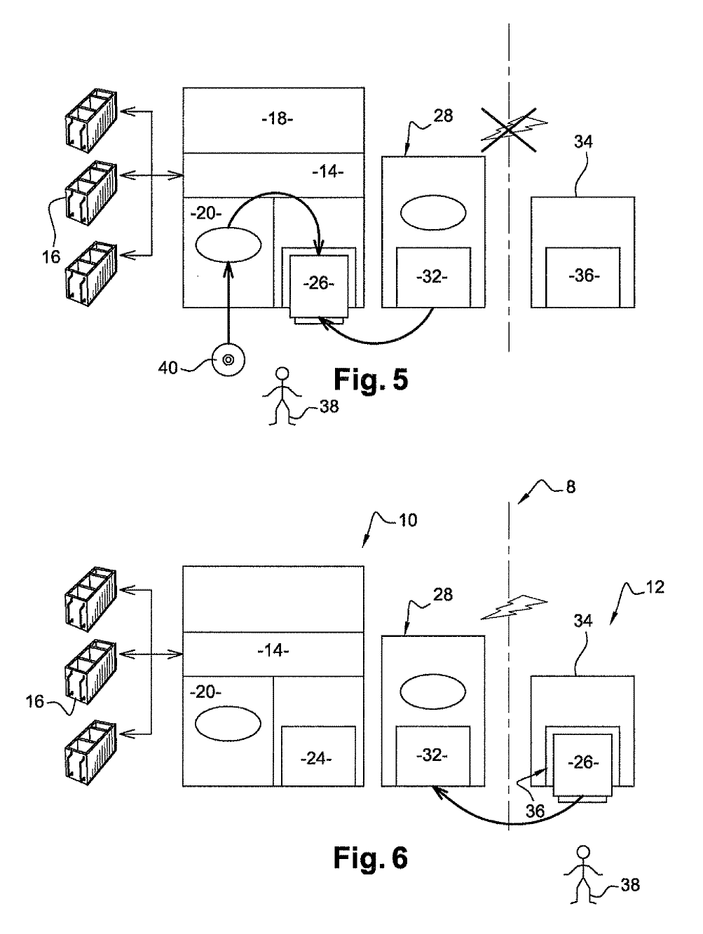

Finally, FIG. 6 shows circumstances in which it is necessary to perform massive updating of the content of the medium 26. It is assumed that the wireless connection is available but that its passband does not enable updating to be performed fast enough. It is also assumed that it is not possible to keep the aircraft on the ground for the excessive length of time that would be required to perform updating with a known method.

The architecture of the system 8 enables an operator 38 to extract the medium 26 from the location 24 or 32 in which it was to be found and to take it away from the aircraft. The operator places the medium in the location 36 of the ground device 34 where it is updated directly. Such massive updating can be performed quickly under such circumstances. Once the updating has been completed, the operator extracts the medium 26 from the location 36 and takes it back onto the aircraft in order to replace it in the location 32.

Another possibility consists in providing a new copy of the medium 26 that has previously been prepared with the necessary updating, e.g. by performing it in advance within the device 34. These operations may advantageously be performed before the aircraft becomes available or even accessible. Once it is possible to board the aircraft, the operator need only extract the old medium 26 from the location 32 (or 24) and place the suitably updated new medium 26 in that location. Under such circumstances, the updated data is thus made available on board the aircraft very quickly without requiring the aircraft to be grounded for a long time.

As can be seen, the invention makes it possible to satisfy the new desires of users in terms of remote access on the ground for updating or managing the configuration of the data medium. The presence of the removable data medium and the on-board updating device provides the user with greater flexibility in managing the content of the data medium without threatening the safety of on-board equipment, in particular concerning data-loading constraints.

The absence of a physical connection between the loading device 14 and the medium 26, while the medium is not in use, provides effective protection against untimely or involuntary loading. The updating device 28 enables the medium to receive data over a wireless connection from outside the aircraft, regardless of whether the aircraft is on the ground or in flight.

This architecture also makes it possible to have configuration differences between the content of the medium 26 and the on-board computers 16. For example, the medium 26 may contain a version n+1 of a piece of software whereas the on-board computer 16 in question contains the version n of the software in question.

The removable nature of the medium 26 enables the time required for reloading the medium to be reduced in the event of the unit 10 suffering a hardware failure. It thus suffices to disconnect the medium from the faulty unit and replace it within a new unit once it has been installed on board. This same removable nature makes it possible to avoid making the design of the unit 26 more complex in order to ensure availability of the data. Thus, there is no need to provide redundancy or a replication mechanism. The unit is thus more reliable. Finally, it is possible for massive updating of the medium 26 to be prepared in advance on the ground at the main base of the airline without affecting the length of time the aircraft needs to remain on the ground. As mentioned above, it suffices to replace the old medium with the new medium on board the aircraft once the aircraft becomes accessible.

The method of the invention or at least one of its steps may be executed by means of a program comprising code instructions suitable for controlling the implementation of the method or of said step when executed on a computer. The program may be stored on a data storage medium such as the media 26 and 40. Finally, the program may be made available on a telecommunications network in order to be downloaded.

Naturally, numerous modifications may be made to the invention without going beyond the ambit thereof.

Provision may be made for the loading device 14 and/or the updating device 28 to have no specific location for receiving the medium 26 and to be suitable for communicating therewith, e.g. over a wireless connection or over a wire, when the medium 26 is located in the proximity of said devices.

Provision may be made for a plurality of storage media 26 to be found on board.

What is claimed is:

1. An on-board unit for an aircraft, wherein the unit comprises:
an updating device dedicated to the aircraft and suitable for sending data relating to on-board equipment to a data storage medium; and
a data-loading device suitable for being connected to the on-board equipment and for receiving the data from the storage medium.

2. A unit according claim 1, wherein the updating device does not have a connection with the loading device.

3. A unit according to claim 1, wherein the loading device and/or the updating device presents a respective predetermined location for removably receiving the data storage medium.

4. An aircraft, including a unit according to claim 1.

5. An aircraft according to claim 4, wherein the updating device is suitable for receiving data relating to the equipment from outside the aircraft over a wireless connection.

6. A method of loading data on board an aircraft, wherein on board the aircraft:
an updating device dedicated to the aircraft sends data relating to equipment of the aircraft to a data storage medium; and
the storage medium sends the data to a data-loading device connected to the equipment.

7. A method according to claim 6, wherein the storage medium is taken from a reception position in which it is suitable for receiving the data from the updating device to a transfer position in which it is suitable for transferring the data to the loading device.

8. A program, including instructions suitable for controlling the execution of at least one of the steps of the method according to claim 6, in the context of implementing said method when the program is executed on a computer.

9. A data storage medium, including, in stored form, a program according to claim 8.

10. A method, including a step of making a program according to claim 8 available for downloading on a telecommunications network.
